(19) United States
(12) Patent Application Publication
(10) Pub. No.: US 2004/0227426 A1
(43) Pub. Date: Nov. 18, 2004

(54) Direct current rotation machine

(76) Inventor: Yi Chae-Chung, Hamburg (DE)

Correspondence Address: SMITH, GAMBRELL & RUSSELL, LLP, 1850 M STREET, N.W., SUITE 800, WASHINGTON, DC, 20036, US

(21) Appl. No.: 10/844,437

(22) Filed: May 13, 2004

(30) Foreign Application Priority Data
May 15, 2003 (DE) 103 21 763.0

(51) Int. Cl. H02K 1/00

(52) U.S. Cl. 310/233

(57) ABSTRACT

A direct current rotation machine induces electric current through installation of rotor 5 (having electromagnetic coil 13, 14 and commutator 15) in stator 10 wound with coil 11, 12 and rotation of rotor 5, there being equalization of number of pole of stator 10 and rotor 5, and number of copper segments of commutator 15 and number of pole of rotation machine, and arrangement of copper segments at both sides in equal number.

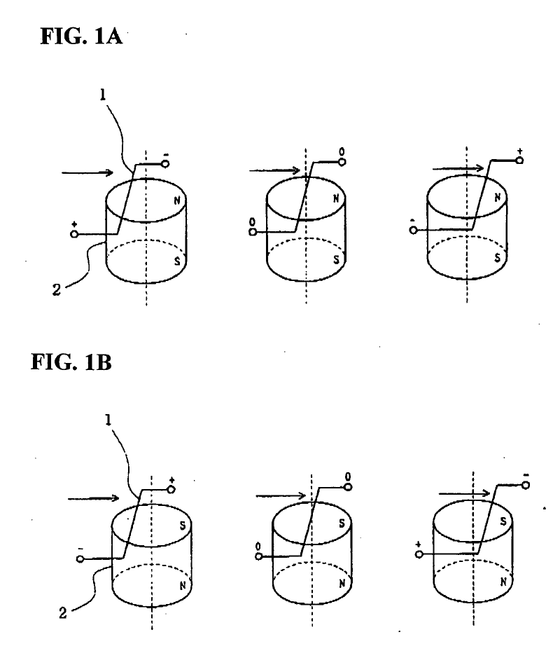

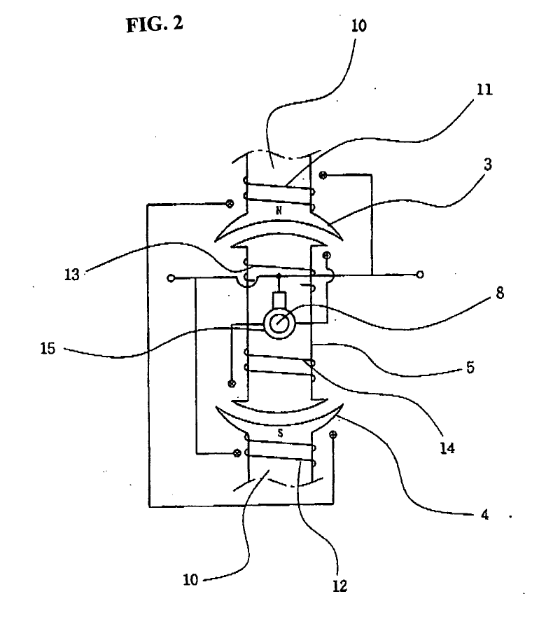

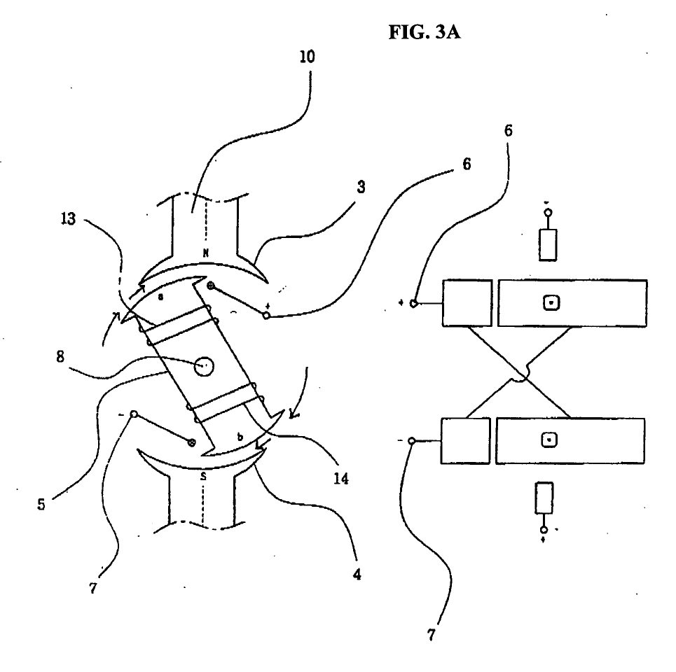

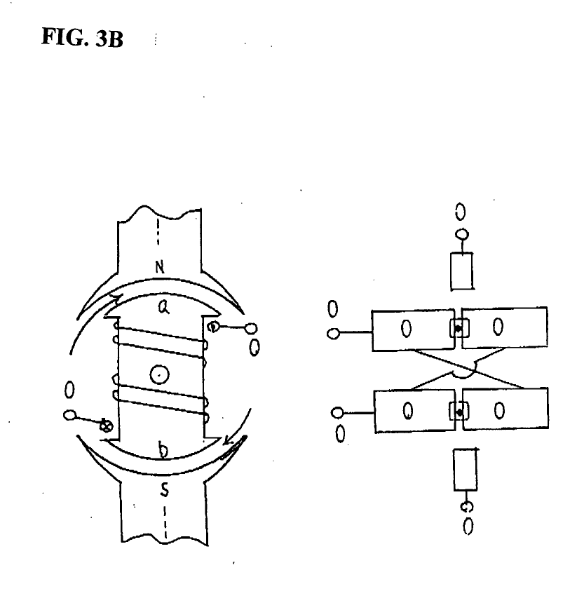

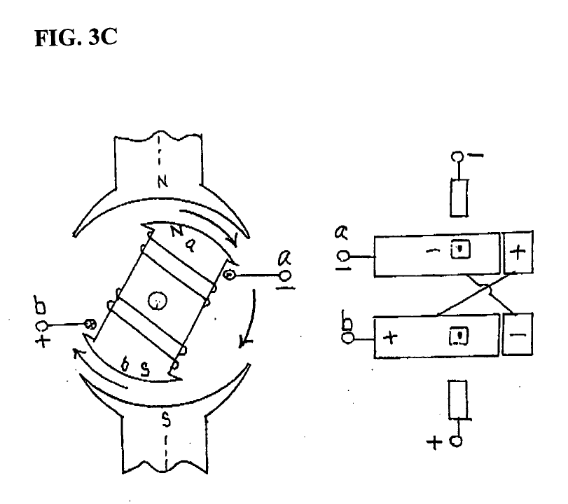

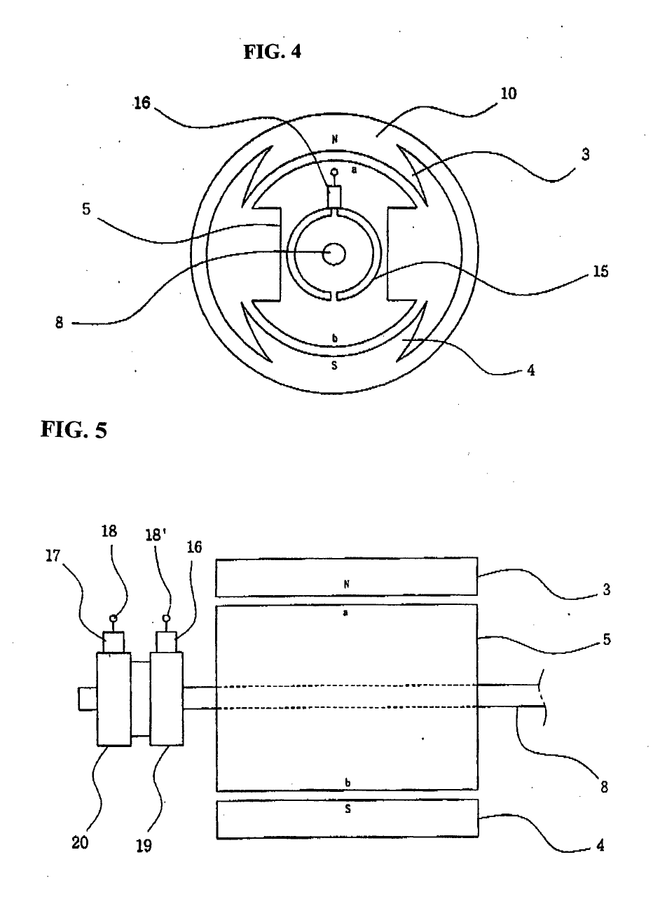

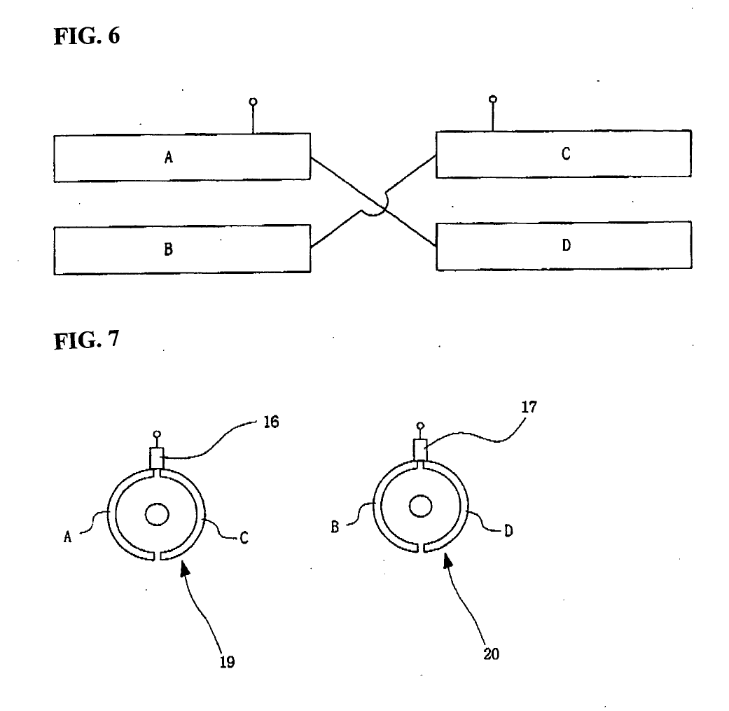

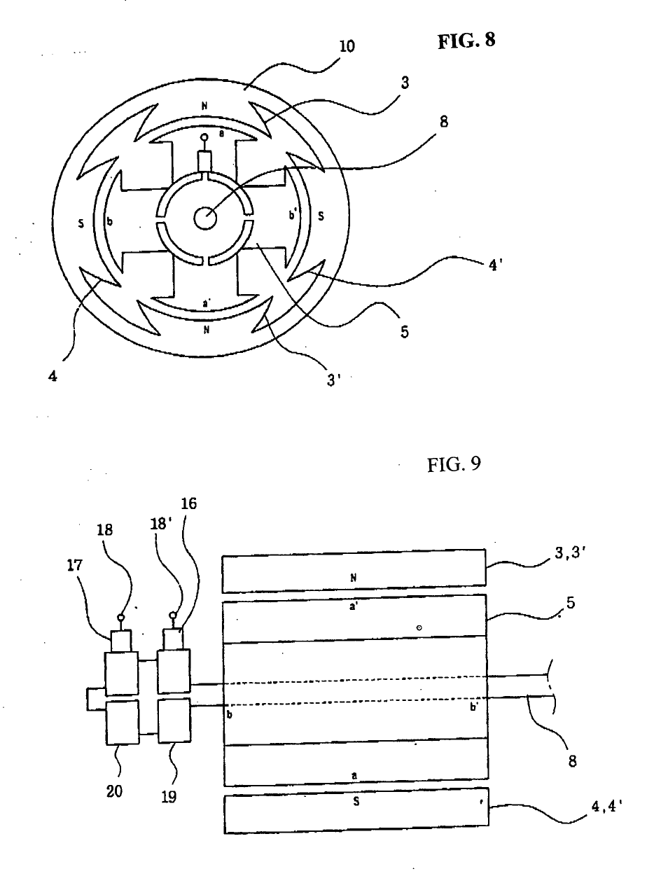

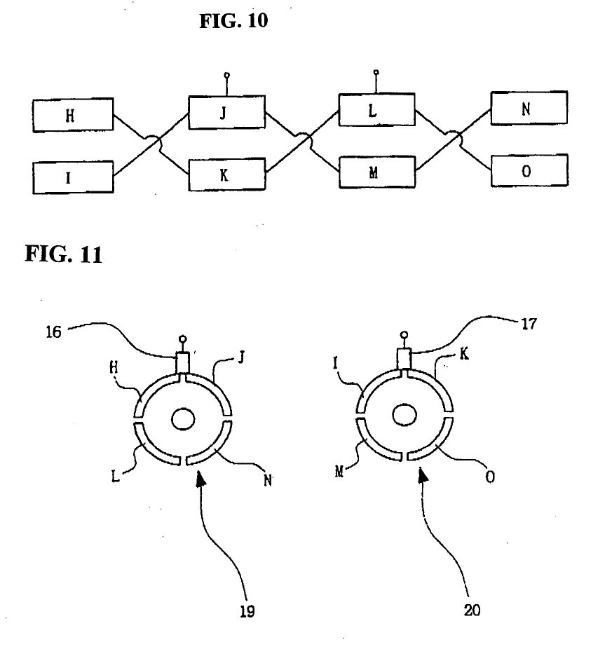

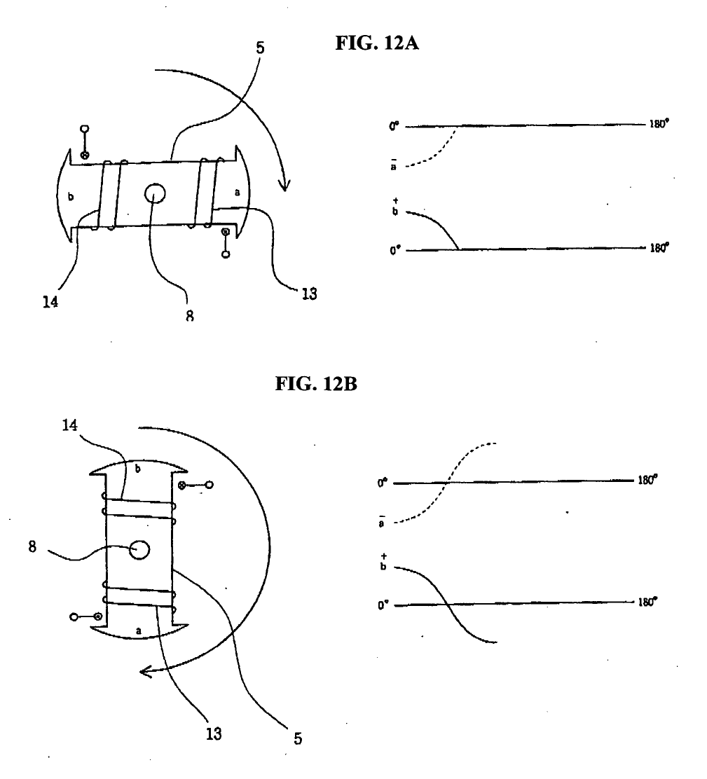

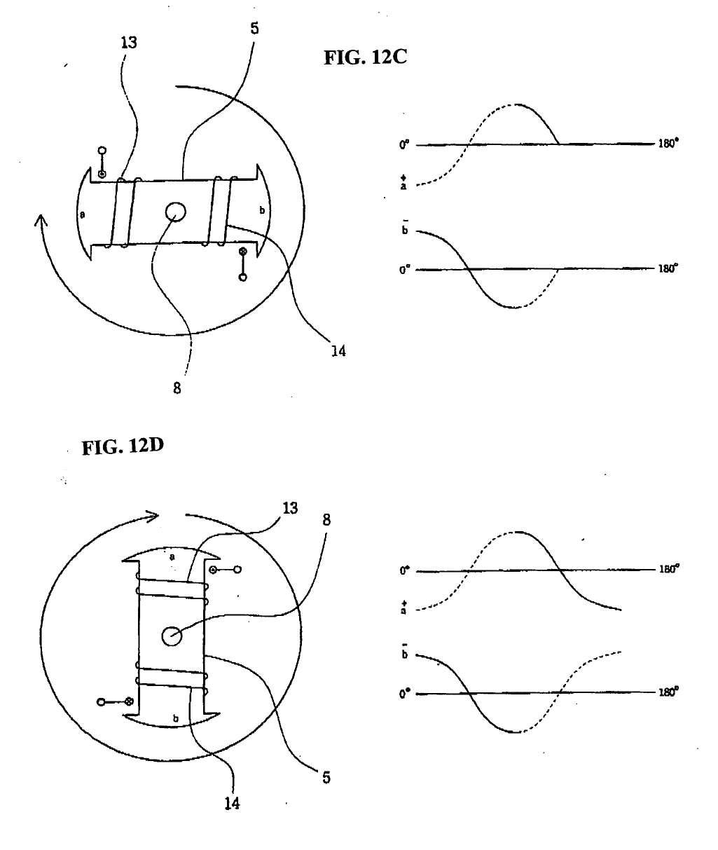

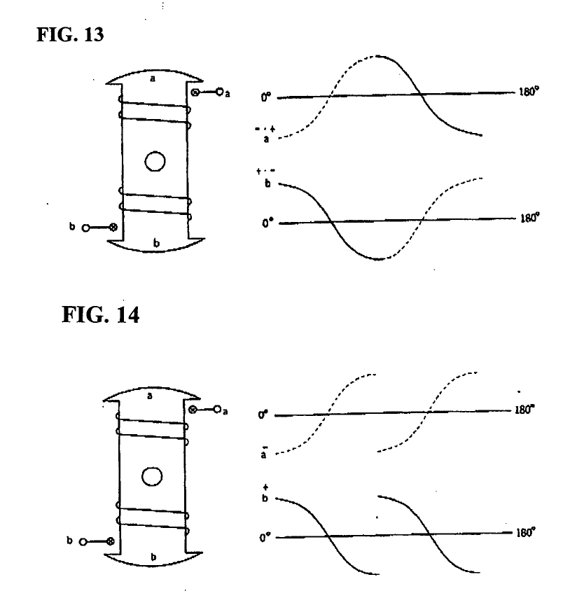

### SUMMARY

A. Technological field of this invention included in the scope of patent application.

This invention is regarding to Direct Current Rotation Machine which maximizes characteristics of direct current output through equalization of number of pole of stator and rotor and improvement of structure of segments of commutator.

B. Technological problem which this invention tries to solve.

Generally, rotation machine includes motor which alters electric energy to mechanical rotating energy and generator which alters mechanical rotating energy to electric energy. Especially, in case of generator, rotor which includes electromagnetic coil and commutator is installed in stator which is wound by coil, and electric current is generated when the rotor revolves. However, in case of conventional direct current rotation machine, number of pole of stator and that of pole of rotor is not equal (for example: stator is 2 pole and rotor is 3 pole) and due to such structure, conventional direct current rotation machine has the weakpoint of getting only approximately 50% of direct current output.

C. Summary of method of solution by this invention

Aim of this invention is to resolve above mentioned problem. Goal of this invention is to furnish the direct current rotation machine which has characteristics of 100% direct current output through equalization of number of pole of stator and rotor and equalization of number of pole of rotation machine and number of copper segments of commutator which are arranged at both sides.

D. Important use of this invention.

Electric rotation machine

### SUMMARY DIAGRAM

Diagram 1a

### BRIEF DESCRIPTION OF DIAGRAMS

Diagram 1a and 1b indicate change of direction of electric current when coil passes magnetic pole.

Diagram 2 indicates wiring of this invention, direct current rotation machine.

Diagram 3a thru 3c indicate operating condition of this invention, direct current rotation machine.

Diagram 4 indicates front view of this invention, 2 pole direct current rotation machine.

Diagram 5 indicates side view of this invention, 2 pole direct current rotation machine.

Diagram 6 indicates coil of rotor connected to commutator which has 4 commutator copper segments (2 pole direct current rotation machine)

Diagram 7 indicates arrangement condition of copper segments used in diagram 6.

Diagram 8 indicates front view of this invention, 4 pole direct current rotation machine.

Diagram 9 indicates side view of this invention, 4 pole direct current rotation machine.

Diagram 10 indicates coil of rotor connected to commutator which has 8 commutator copper segments (4 pole direct current rotation machine)

Diagram 11 indicates arrangement condition of copper segments used in diagram 10.

Diagram 12a thru 12d indicate Oscilloscope display of shape of alternating current wave at the time AC rotation machine revolves one (1) cycle.

Diagram 13 indicates OScilloscope display of shape of Alternating current wave at the time of rotation with slop ring.

Diagram 14 indicates Oscilloscope display of shape of direct current wave at the time of rotation with direct current commutator.

### DESCRIPTION OF MAJOR SYMBOLS OF DIAGRAMS

| | |
|---|---|
| 3, 4: Magnetic pole of stator | 5: Rotor |
| 6, 7: Terminal of rotor coil | 8: Axis |
| 10: Stator | 11, 12: Stator coil |
| 13, 14: Rotor coil | 15: Commutator |
| 16, 17: Brush | 18, 18′: Output terminal |
| 19, 20: Commutator ring | |

### DETAIL DESCRIPTION OF INVENTION

### PURPOSE OF INVENTION

Technological Field of this Invention and Conventional Technology

This invention is regarding to Direct Current Rotation Machine which maximize characteristics of direct current output through equalization of number of pole of stator and rotor and improvement of structure of segments of cummutator.

Generally, rotation machine includes motor which alters electric energy to mechanical rotating energy and generator which alters mechanical rotating energy to electric energy. Especially, in case of generator, rotor which includes electromagnetic coil and cummutator is installed in stator which is wound by coil, and electric current is generated when the rotor revolves.

However, in case of conventional direct current rotation machine, number of pole of stator and that of pole of rotor is not equal (for example: stator is 2 pole and rotor is 3 pole) and due to such structure, conventional direct current rotation machine has the weakpoint of getting only approximately 50% of direct current output.

Method of Solution of Problem by this Invention

Aim of this invention is to resolve above mentioned problem. Goal of this invention is to furnish the direct current rotation machine which has characteristics of 100% direct current output through equalization of number of pole of stator and rotor and equalization of number of pole of rotation machine and number of copper segments of commutator which are arranged at both sides.

Structure and Detail Explanation of Invention

Detail function of this invention is explained referring to attached diagrams as below. First of all, in explanation of each diagram, identical referring symbol is used for identical structural element even though it is indicated in other diagrams.

Diagram 1a and 1b indicate alteration of direction of electric current at the time coil passes magnetic pole. When coil passes magnetic pole, direction of electric currency of both terminals is altered at the center of pole.

Another word, diagram 1a indicates alteration of direction of electric currency when coil (1) passes (from left direction to right direction) cylindrical magnetic field whose upper portion is N pole and lower portion is S pole. Coil (1) terminal near N pole becomes (−) polarity and coil (1) terminal near S pole becomes (+) polarity while moving to right direction and coil (1) terminals becomes zero polarity exactly at the center of pole of cylindrical magnetic field (2), and when coil (1) moves to right direction passing the center of the pole, coil (1) terminal near N pole becomes (+) polarity and coil (1) terminal near S pole becomes (−) polarity, this means direction of electric current alters based on starting point of center of pole.

Diagram 1b indicates alteration of direction of electric currency when coil passes (from left direction to right direction) cylindrical magnetic field whose upper portion is S pole and lower portion is N pole. Coil (1) terminal near S pole becomes (+) polarity and coil (1) terminal near N pole becomes (−) polarity while moving to right direction and coil (1) terminals become zero polarity exactly at the center of pole of cylindrical magnetic field (2), and when coil (1) moves to right direction passing the center of the pole, coil (1) terminal near S pole becomes (−) polarity and coil (1) terminal near N pole becomes (+) polarity.

Diagram 2 indicates wiring concept of this invention, direct current rotation machine. Direct current rotation machine consists of rotor (5) which rotate on the axis (8) and stator (10) which is connected to machine with magnetic power. Stator (10) has magnetic field by mean of coil (11) (12) wound on it and it has magnetic pole (3) (4) of crossed both polarities expanded around circular orbit which surrounds axis of rotor (5).

Rotor (5) has coil (13) (14) which are wound oppositely and one end of these coils (13) and (14) is connected with end of terminals. Also, rotor (5) has commutator (15) which is wound appropriately for output of direct currency.

Diagram 3a thru 3c indicates operational condition of this invention, direct currency rotation machine. Rotor (5) rotates circular orbit of magnetic poles (3) (4) of stator (10) clockwise centering around axis (8) of rotor, and this diagram indicates operating condition of direct currency rotation machine and arrangement of copper segments of commutator at the time poles ((a) (b) of rotor (5) becomes in a line with poles (3) (4) of stator and before and after. Through this, we can understand that commutator (15) alters direction of electric currency when rotor (5) of direct currency rotation machine rotates one (1) cycle.

Another word, diagram 3a indicates operating condition befor poles (3) (4) of stator (10) becomes in a line with poles (a) (b) of rotor (5). Output electric currency of (+) polarity is generated at the one terminal of Coils (13) (14) and output electric currency of (−) polarity is generated at another terminal.

Diagram 3b indicates operating condition at the time poles (3) (4) Of stator becomes a line the poles (a) (b) of rotor (5). When center of pole of rotor (5) comes exactly to the center of pole of stator (10), both terminals (6) (7) of coils (13) (14) become zero (0) polarity and there is no output. Consequently, it is desirable that commutator (15) of direct currency rotation machine is located at the proper place to commutate output of rotor (5).

Diagram 3c indicates operation condition after poles (3) (4) of stator (10) became in a line with poles (a) (b) of rotor (5). After rotor (5) passed center of pole of stator (10), output electric currency is generated and at this time, polarity of both terminals (6) (7) of coils is opposite to that indicated in above mentioned diagram 3a.

Diagram 4 indicates front view of this invention, 2 pole direct currency rotation machine, and diagram 5 indicates side vview of this invention, 2 pole direct currency rotation machine, and diagram 6 indicates coil of rotor connected to commutator which has 4 commutator copper segments (2 pole direct currency rotation machine). And diagram 7 indicates arrangement of commutator copper segments used in diagram 6.

As indicated on above mentioned diagram 4 thru 7, number of pole of stator (10) and rotor (5) of 2 pole direct currency rotation machine is identically 2 pole, and number of copper segments (A)(B)(C)(D) of commutator (15) is identical to number of pole of rotation machine and copper segments are placed at both sides concidentally with pole of rotation machine.

Commutator (15) is inserted to outer axis (8) of stator (10), and brush (16) (17) which is arranged to the direction of axis (8) is connected to output terminals (18) (18′) respectively. Above mentioned commutator (15) includes two (2) commutator rings (19) (20) which possess two (2) identical copper segments respectively.

Accordingly, Above mentioned ring (19) has copper segments (A) (C) which are arranged in a line respectively with copper segments (B) (D) of another ring (20), and since direction of electric currency is altered at each half cycle, these copper segments are connected oppositely as indicated in diagram 6.

In order to coincide center of pole of stator (10) with gap portion of commutator (15) when rotor (5) comes to the center of pole of stator (10) while it revolves, gap portion of commutator (15) is fixed at the center of pole of rotor (5).

Diagram 8 indicates front view of this invention, 4 pole direct current rotation machine and diagram 9 indicates side view of this invention, 4 pole direct currency rotation machine, and diagram 10 indicates coil of rotor connected to commutator which has 8 commutator copper segments (4 pole direct currency rotation machine). And diagram 11 indicates arrangement of commutator copper segments used in diagram 10.

As indicated in diagram 8 thru 11, poles of stator (10) and rotor (5) are identically 4 pole crossing each other (4 pole direct currency rotation machine), and number of copper segments of commutator (15) is identical to number of pole of rotation machine and copper segments are arraged at both sides identically.

In case of 4 pole direct currency rotation machine, commutator (15) is also inserted to outer axis (8) of stator (10), and brushes (16) (17) which are arranged to the direction of axis (8) are connected to output terminals (18) (18′) respectively. Above mentioned commutator (15) includes two (2) commutator rings (19) (20) which has 4 identical copper segments respectively.

Accordingly, above mentioned ring has copper segments (H)(J)(L)(N) which are arranged in a line respectively with copper segments (I)(K)(M)(O) of another ring, and since direction of electric currency is altered at each half cycle, these copper segments are connected oppositely each other as indicated in diagram 10.

In order to coincide center of pole of stator (10) with gap portion of commutator (15) when rotor (5) comes to the center of pole of stator (10) while it revolves, gap portion of commutator (15) is fixed at the center of pole of rotor (5).

diagram 12a thru 12d indicates Oscilloscope display of shape of AC wave at the time of one (1) cycle rotation of AC rotation machine. Shape of AC wave indicated in line means (+) polarity and shape of AC wave indicated in dotted line means (−) polarity.

In the order of diagram 12a thru 12d, until rotor (5) rotates half cycle clockwise on the center of axis (8), terminal a of coil (13) (14) of rotator shows shape of AC wave of (−) polarity and terminal b shows shape of AC wave of (+) polarity but when rotation of rotor (5) passes half cycle, terminal a shows shape of AC wave of (+) polarity and terminal b shows shape of AC wave of (−) polarity.

Diagram 13 indicates Oscilloscope display of shape of AC wave at the time of rotation with Slip Ring, and diagram 14 indicates Oscilloscope display of shape of DC wave at the time of rotation with direct current commutator. As you can see on the diagram, this invention, direct current rotation machine assures obtainment of characteristics of 100% direct current output.

Practical operations of this invention has been explained as set forth above, however, it is clear that many ways of modifications and alterations can be applicable within the scope of technological concept of this invention. For example, this invention was described here based on 2 and 4 pole machines but 6 pole or more pole may be applicable to this invention also.

Effect of this Invention

As mentioned befor, this invention, direct current rotation machine can achieve strong electromotive force and commutate Alternating Current to Direct Current 100%, therefore, this invention, direct current rotation machine has the effect of promoting productivity.

1. A direct current rotation machine induces electric current through installation of rotor (having electromagnetic coil and commutator) in stator wound with coil and rotation of rotor, there being equalization of number of pole of stator and rotor, and number of copper segments of commutator and number of pole of rotation machine, and arrangement of copper segments at both sides in equal number.

2. The rotation machine of claim 1, wherein the commutator includes two commutator rings which have number of copper segments identical to number of pole of rotation machine.

3. The rotation machine of claim 1, characterized by fixing gap portion of commutator at the centre of rotation machine.

4. The rotation machine of claim 2, characterized by fixing gap portion of commutator at the centre of rotation machine.
